(19) United States
(12) Patent Application Publication
(10) Pub. No.: US 2007/0097066 A1
(43) Pub. Date: May 3, 2007

(54) LCD display utilizing light emitters with variable light output

(76) Inventor: Calvin B. Ward, Castro Valley, CA (US)

Correspondence Address: AVAGO TECHNOLOGIES, LTD., P.O. BOX 1920, DENVER, CO, 80201-1920, US

(21) Appl. No.: 11/262,110

(22) Filed: Oct. 27, 2005

(51) Int. Cl. G09G 3/36

(52) U.S. Cl. 345/102

(57) ABSTRACT

A display having a light source, an LCD panel, and a controller and a method for displaying an image on an LCD panel are disclosed. The light source includes a first light emitter that generates a first light signal having first and second intensities. The LCD panel is illuminated by the first light signal. The controller controls the state of the LCD elements and the intensity of the first light signal in response to receiving an image to be displayed by the LCD panel. The image includes a first sub-image and a second sub-image, the controller causing the first sub-image to be displayed when the first light signal has the first intensity and the second sub-image to be displayed when the first light signal has the second intensity. The first and second sub-images are displayed in a time period that is less than 0.03 seconds.

### BACKGROUND OF THE INVENTION

LCD displays are rapidly replacing CRT and plasma displays as the monitor of choice. Large high-resolution CRT displays weigh more than the average person can lift comfortably. In addition, CRT displays are power intensive and suffer from image burn-in problems if the same scene is displayed for a long time on the screen. The light output of a CRT is also limited, particularly in high-resolution displays.

Large plasma displays are lighter in weight than the corresponding CRT display and can provide much brighter images. However, plasma displays also exhibit image burn-in. Furthermore, high-resolution plasma monitors for use in computers have not been available at a price that can compete with LCD displays.

An LCD display is typically constructed from an array of LCD elements that are backlit with an appropriate light source. Each LCD element may be viewed as a light shutter that either transmits or blocks light. A full color image is created by generating three component color images and presenting the component images to the viewer in a manner in which the user perceives the component images as being super-imposed on one another. For simplicity it will be assumed that the three component images are the conventional red, green, and blue images. That is, the red component image is the image that would be seen in the red portion of the optical spectrum, and so on.

One method commonly used for super-imposing the images is to display the images simultaneously, but offset slightly in space. This is the technique used in most conventional CRT display systems and commercially available LCD television and computer displays. The array of LCD elements is backlit via a white light source that utilizes a fluorescent tube or tubes. Each LCD element includes a color filter that selects light of one color from the white light that illuminates that element. The elements are grouped together such that a red element is adjacent to a blue element and a green element. The red elements display the red component image, and so on. Hence, the three color component images are offset from each other by a distance corresponding to one LCD element. If this distance is small, the user's vision system will not be able to distinguish the light from the individual LCD elements, and hence, the user will perceive the component images as being super-imposed on one another. To generate an image having N pixels or color points, 3N LCD elements must be used.

In this type of display, the perceived intensity of light at each LCD element is varied by adjusting the time period in which the shutter is open rather than by altering the intensity of the light passing through the shutter. The human eye cannot follow changes in intensity that occur over times that are less than a minimum time that depends on the physiology of the eye. If a light source varies in intensity during a time period that is less than this minimum, the eye measures only the average light intensity reaching the eye during the time period. Hence, a first element that is open for twice the time that a second element is open appears to be twice as bright, even though the actual intensity of light leaving each element is the same during the time periods in which the elements are open, provided the maximum time over which either pixel is open is less than this minimum time.

The light source used to illuminate the LCD panel is typically constructed from a light guide that has a surface that is as large as the LCD panel. The light guide is typically a thin rectangular chamber that is illuminated along the edge by a white light source such as a fluorescent tube or an incandescent light. The light is reflected back and forth within the light guide such that the upper surface of the light guide is uniformly illuminated. Some of the light striking the upper surface escapes this surface and impinges on the LCD panel.

Light emitting diodes (LEDs) have been suggested as replacements for conventional white light sources. The LEDs have higher light conversion efficiencies than incandescent lights and much longer lifetimes. In addition, the LEDs can be driven from low voltage sources. Further, the cost and power advantages of LEDs are expected to continue to improve in the future.

LCD display panels based on LEDs are similar to the white light illuminated panels with the white light source being replaced by an LED source that generates light in the three color bands. The LEDs are arranged in a linear array along one or more of the edges of a light guide which acts as a mixing chamber that mixes light from red, blue, and green discrete LED sources to provide a white light source that replaces the conventional fluorescent or incandescent sources. While such sources have advantages over the conventional sources, the resulting displays fail to take advantage of the inherent other advantages of semiconductor light sources.

For example, the red LCD elements will only pass light in the red region of the spectrum, and hence, any blue or green light striking these pixels is wasted. In addition, the red filters absorb some fraction of the red light incident on the filters, and hence, even some of the red light is wasted at the red LCD elements. The same factors result in similar light losses at the other LCD elements. As a result, only a small fraction of the light generated by the light source actually reaches the viewer even during the periods in which the shutters are open. To compensate for these light losses, the LED light source must generate additional light, and hence, utilize additional power and LEDs. This increases the cost of the light source, the amount of heat that must be dissipated, and the power consumed by the display. In applications in which the power is provided by a battery, e.g., laptop computers and handheld devices, this increased power is particularly problematic.

Frame sequential displays have been suggested as a possible solution to the inefficient use of the light source in LED-based LCD displays. In a frame sequential display, the red, blue, and green component images are super-imposed in space, but displaced slightly in time. For example, the red image is displayed, then the green image, and then the blue image. If the time periods over which the images are displayed are sufficiently short, the eye of the observer only perceives the average of the three images, and hence, the user perceives the images as if they were displayed simultaneously in time. The individual color images are displayed by using a light source of the corresponding color rather than starting with white light and then filtering out the unwanted portion of the spectrum. For example, the red image is displayed by illuminating the light guide with light from one or more red LEDs. After the red image is displayed, the red light emitters are turned off, and the light source is switched to blue light emitters, and the blue image is displayed, and so on. Hence, no color filters are required on the LCD elements. In addition, the same LCD elements can be used for each image, and hence, only N LCD elements are needed.

While a frame sequential display would seem to provide solutions to the problems discussed above, such displays have not found wide acceptance because of other problems related to the slow switching speed of the LCD elements. Consider a motion picture that is to be played on a frame sequential display in which the display is to have a resolution of N pixels. Each frame of the motion picture must be displayed as a sequence of three color component images, as opposed to a single frame on a 3N pixel image. Hence, the display time is three times longer with a frame sequential display. The minimum time needed to display an image depends on the switching time of the LCD elements and the desired contrast ratio in the image. As noted above, the intensity at each LCD element is controlled by controlling the amount of time the LCD element transmits the light incident on that element. Consider a display that is to provide 256 intensity values, 0 through 255. The time between frames must be at least 256 time periods. The display time for each component image is divided into 255 time periods. Consider a pixel that is to have an intensity of 1. The LCD element for that pixel is opened at the beginning of the display period and then closed at the end of the first time period. A pixel that has an intensity of 2 opens at the beginning of the frame and then closes at the end of the second time period, and so on. Hence, a time sequential display with 256 intensity levels requires 3 times 255 time periods to display a frame of the motion picture. In contrast, the conventional displays require only 255 time periods. It should be noted that a motion picture typically requires 30 frames per second. Hence, a frame sequential display must utilize time periods that are less than 50 μsec in length. This is a problem for inexpensive LCD display elements.

The minimum time period is determined by the switching time of the LCD elements. In the case of a pixel that opens for one time period, the light intensity corresponds to the time required to open the LCD element, the time over which the pixel is fully open, and the time required to turn off the LCD element. Since the average light intensity for the pixel having an intensity of 1 must be half the average light intensity of a pixel having an intensity of 2, the time over which the pixel is fully open must be much larger than the switching times or the display will exhibit significant non-linearity at low intensities. Hence, the switching time of the LCD elements must be much less than the 50 μsec time period discussed above.

In addition, the long display times result in other color artifacts. Consider a display operating at 30 frames a second. Each color image is present for 1/90 of a second or about 10 msec. Consider the case in which the viewer's view of the display is interrupted for a time period of the order of 10 to 20 msec. Such interruptions can occur when the viewer blinks his or her eyes. The viewer will miss one or two color component images and see the remaining component image or images of that frame. This will result in a perceived color shift in the image, since one or two colors will have been lost. The resultant color shifts are disturbing to many individuals.

### BRIEF DESCRIPTION OF THE DRAWINGS

FIG. 1 is a top view of light source 10 illustrating a prior art light box arrangement for illuminating an LCD display.

FIG. 2 is a cross-sectional view of light source 10 through line 2-2 shown in FIG. 1.

FIG. 3 is a simplified cross sectional view through a portion of a light guide and three pixels that are illuminated by light from the light guide.

FIG. 4 is a simplified cross-sectional drawing of a display 70 according to one embodiment of the present invention.

FIG. 5 illustrates a prior art linear light source.

FIG. 6 is a top view of an LCD display according to another embodiment of the present invention.

### SUMMARY OF THE INVENTION

The present invention includes a display having a light source, an LCD panel, and a controller and a method for displaying an image on an LCD panel. The light source includes a first light emitter that generates a first light signal having first and second intensities that are greater than zero, the second light intensity being different from the first light intensity. The LCD panel includes a plurality of LCD elements, each LCD element having a first state in which that LCD element transmits light and a second state in which that LCD element blocks light. The LCD panel is illuminated by the first light signal. The controller controls the states of the LCD elements and the intensity of the first light signal in response to receiving an image to be displayed by the LCD panel. The image includes a first sub-image and a second sub-image, the controller causing the first sub-image to be displayed when the first light signal has the first intensity and the second sub-image to be displayed when the first light signal has the second intensity. The first and second sub-images are displayed in a time period that is less than 0.03 seconds. In one embodiment of the invention, the first light signal includes light in a first band of wavelengths, and the light source further includes a second light emitter that generates a second light signal having third and fourth intensities that are greater than zero. The third intensity is different from the fourth intensity. The second light signal includes light in a second band of wavelengths that is different from the first band of wavelengths. The received image further includes third and fourth sub-images, the controller causing the third sub-image to be displayed when the second light signal has the third intensity and the fourth sub-image to be displayed when the second light signal has the fourth intensity. The first, second, third, and fourth sub-images are displayed in a time period less than 0.03 seconds. In one embodiment, the first sub-image is displayed first and the third sub-image is displayed before the second sub-image.

In one embodiment, the first light source includes a light pipe having a layer of transparent material having a top surface, a bottom surface, and a first edge surface. The light pipe is positioned to receive light from the first light emitter through the first edge surface such that the light is totally reflected from the top surface. The light pipe includes features that redirect some of the light such that some of the redirected light exits through the top surface, the LCD panel overlying the top surface.

The method for displaying an image according to the present invention includes generating first and second sub-images from the image. The first sub-image is displayed on an LCD panel using a first light intensity of light from a first light source characterized by a first output spectrum to illuminate the panel, and the second sub-image is displayed on the LCD panel using a second light intensity from the first light source to illuminate the panel. The first and second sub-images are displayed in a time period that is less than 0.03 seconds.

In one embodiment, third and fourth sub-images are generated from the image. The third sub-image is displayed on the LCD panel using a third light intensity of light from a second light source to illuminate the panel. The second light source is characterized by a second output spectrum at the third intensity that is different from the first output spectrum. The third intensity is different from the fourth intensity, and both of the third and fourth intensities are greater than zero. The fourth sub-image is displayed on the LCD panel using a fourth light intensity of light from the second light source to illuminate the panel. The first and second, third, and fourth sub-images are displayed in a time period that is less than 0.03 seconds.

### DETAILED DESCRIPTION OF THE PREFERRED EMBODIMENTS

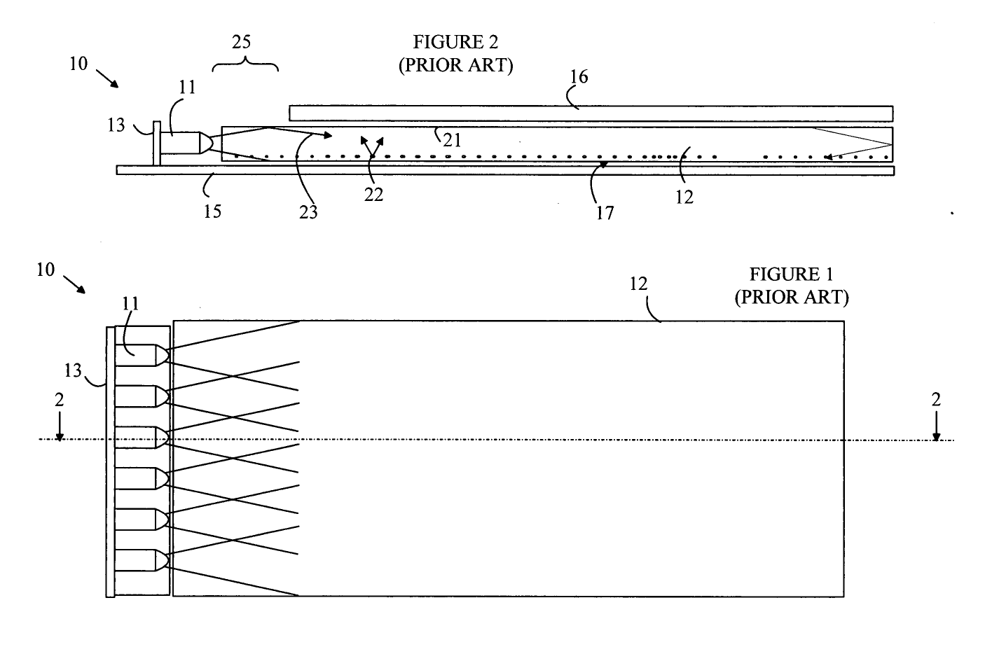

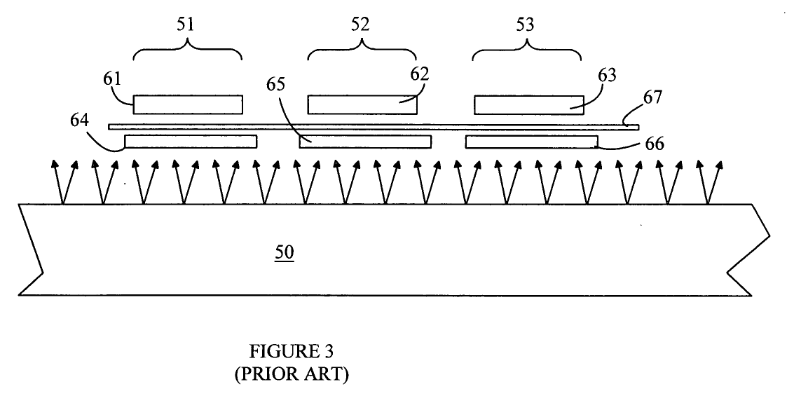

The manner in which the present invention provides its advantages can be more easily understood with reference to FIGS. 1 and 2, which illustrate a prior art light box arrangement for illuminating an LCD display 16. FIG. 1 is a top view of light source 10, and FIG. 2 is a cross-sectional view of light source 10 through line 2-2 shown in FIG. 1. Light source 10 utilizes an array of LEDs 11 to illuminate a light pipe 12. The LEDs are mounted on a circuit board 13 that is mounted on a second board 15 that provides power to the LEDs. The LEDs are positioned such that light leaving the top of each LED illuminates the end of light pipe 12. The light 23 entering light pipe 12, at an angle with respect to the surface 21 that is less than the critical angle, is reflected back and forth within light pipe 12 until the light is either absorbed or scattered by particles 22 on surface 17. The scattered light that strikes surface 21 at angles greater than the critical angle escapes from the light pipe and illuminates the back surface of LCD display 16. The bottom surface of the light pipe is covered with a reflective material; hence, any light striking the bottom surface is reflected upward.

The LEDs are typically selected to emit red, blue and green light in the proper ratios of intensities to provide a white light source. Region 25 near the array of LEDs acts as a mixing region. Hence, the display is mounted at a location that is displaced from the LEDs to allow the “hot spots” associated with the individual LEDs to be averaged, thus providing a source of uniform intensity and color.

Refer now to FIG. 3, which is a simplified cross sectional view through a portion of a light guide 50 and three pixels 51-53 that are illuminated by light from the light guide. Since the details of LCD arrays are known to the art, they will not be described in detail here. For the purposes of the present discussion it is sufficient to note that each pixel includes a shutter and a bandpass filter that selects a particular band of wavelengths from the white light source. The shutters corresponding to pixels 51-53 are shown at 61-63, respectively, and the bandpass filters are shown at 64-66,respectively. The light entering the shutters must be polarized in a predetermined direction. Hence, a polarization filter 67 is also included.

To provide a color display that can display scenes having points of arbitrary color, each point is constructed by mixing light of three colors at the appropriate intensities. Typically, three pixels are used to represent each point in the scene. The three pixels have different color filters, and hence, can provide light of the required colors; however, since the intensity of the light source is fixed, the intensity of the component colors for the points cannot be set by changing the intensity of light that enters each pixel. This problem is overcome in prior art displays by making use of the observation that the human eye averages the light intensity at each point on the retina over a relatively long time interval. That is, the eye only sees the average light intensity over this time interval. Denote the time over which a frame of a motion picture is displayed by T and the period of time over which the shutter is open, i.e., passes light, by t. A viewer of the pixel sees a colored dot of constant intensity having an apparent intensity that is proportional to t/T, provided T is sufficiently short.

In prior art displays, the intensity is set to a digital value. Hence, the smallest non-zero intensity is proportional to 1/T and the largest intensity value is proportional to M/T where M=2^{k}−1, and k is the number of bits of color intensity for which the display is designed. M is also the contrast ratio. Typically contrast ratios for commercial LCD displays are 500:1. That is, k is 9.

The present invention is based on the observation that a color image can be generated by presenting the red, blue, and green component images to the viewer in a sufficiently short period of time rather than presenting all three images simultaneously as done in the prior art. It should be noted that the prior art light sources discussed above can be viewed as three separate component light sources in which each component light source generates the color for one of the component images. That is, when the red image is being generated, only the red LEDs are turned on. As a result, the color bandpass filters discussed above can be eliminated. Furthermore, since each LCD element is used to generate all three colors in the image for the corresponding point, only N LCD elements are now needed to generate the image. Accordingly, higher resolution displays can be provided at a cost comparable to that of existing displays. Finally, as will be explained in more detail below, by manipulating the intensity of light generated by the LEDs during each component image, substantially higher contrast ratios and/or shorter display times can be obtained.

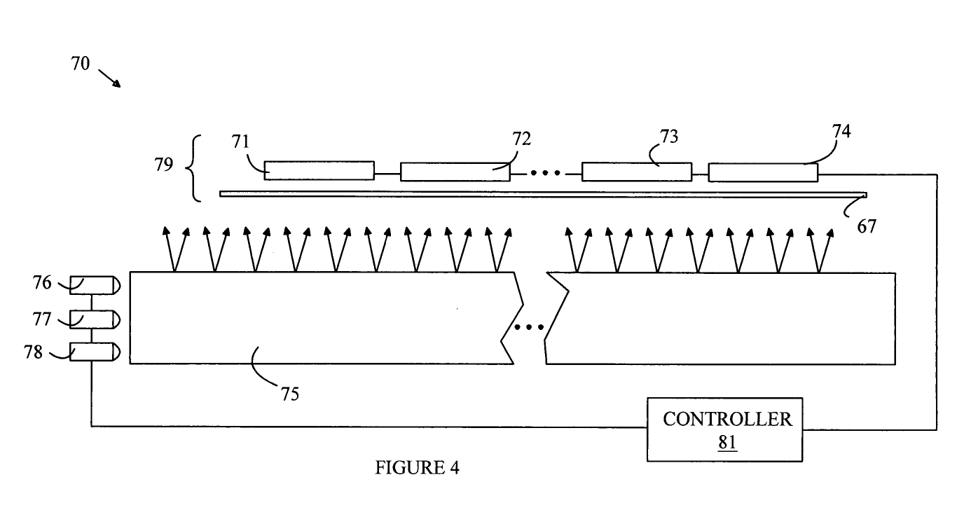

Refer now to FIG. 4, which is a simplified cross-sectional drawing of a display 70 according to one embodiment of the present invention. Display 70 has an LCD shutter array 79. Exemplary shutters are shown at 71-74. A polarizing filter 67 assures that the light entering the shutters has the appropriate polarization. The LCD shutter array is illuminated by light leaving a light guide 75, which functions in a manner analogous to that described above. Light guide 75 is illuminated by three linear arrays of LEDs. To simplify the drawing and the discussion, the arrays of LEDs are shown stacked vertically over one another at 76-78. Each array extends in a direction perpendicular to the plane of the drawing. Each array generates light of a particular color. For the purposes of this discussion it will be assumed that array 76 generates red light; array 77 generates green light, and array 78 generates blue light. A controller 81 controls the intensity of the light generated by the LEDs and the state of the shutters.

The manner in which a component image is generated will now be discussed in more detail. A component image consists of N intensity values for the N pixels of that image for the color in question. There is one such component image for each color. Each intensity value controls the time that a corresponding one of the shutters is in the transparent state. Assume that a red image is to be generated. The red image will be generated over a frame time, T. The time from the start of the frame will be denoted by t in the following discussion. To simplify the discussion, it is assumed that t is an integer and t=M corresponds to time T. Denote the intensity to be displayed at pixel j by Iⱼ, which is also an integer. At the beginning of the frame all of the shutters are closed and all of the light sources are off. At the start of the frame, or just slightly before the start of the frame, the red light source is turned on. At t=0, all of the shutters for which Iⱼ>0 are opened and the red light source 76 is turned on. At time t, all of the shutters corresponding to pixels having Iⱼ=t are closed and remain closed for the duration of the frame. At t=T, the red light source is turned off. The procedure is then repeated with the green light source and the blue light source.

As noted above, there is an upper bound on T. Since the images are being presented serially to the user, the maximum value for T in the embodiment discussed above is T₀/3, where T₀ is the maximum value for T in the prior art schemes in which the images are generated simultaneously. Hence, this type of frame sequential display would need to have lower contrast ratios or faster switching LCD elements.

The present invention makes use of the observation that substantially higher contrast ratios and/or reduced frame display times can be constructed by varying the intensity of the component light source during the generation of the component image. As noted above, the eye only measures the mean intensity of the light originating at each pixel. Hence, a light signal having an intensity of one unit that is turned on for 10 time periods is perceived as having the same intensity as a source having an intensity of 10 units of intensity that is turned on for only one time period, provided the time periods are sufficiently small.

Assume that each intensity value is expressed as a K bit integer. Here, K=logM, where M is the maximum intensity value for the component image. Consider a light source that has K separate intensity levels, Iₖ=I₀2^{k}, where I₀ is a constant. Each frame display time is divided into K intervals corresponding to k running from 1 to K. At the start of the frame, the light source is at its maximum intensity, i.e., I₀2^{k}, and all of the shutters are closed. Consider the jth pixel in the component image being displayed and denote the bits of its desired intensity value by n₁, n₂, . . . , n_{K}, where each n value is either 1 or 0, and n₁ is the most significant bit of the intensity value. At interval k, the intensity is set to Iₖ as defined above and the controller that sets the shutters examines the kth bit of each intensity value for each pixel shutter. If nₖ=1, the corresponding shutter is opened. If nₖ=0, the corresponding shutter is closed.

Hence, only logM time intervals are required to generate a display having a maximum contrast ratio of M:1. As noted above, typical contrast ratios are of the order of 500. Hence, an embodiment of the present invention with a K of 9 can provide the same contrast ratio in 9 time intervals as a conventional LCD display that utilizes 500 time intervals. Accordingly, even after increasing the display time by a factor of 3 so that the component images can be displayed serially, the present invention can complete the frame in substantially less time. The time saved can be used to provide even greater contrast values or faster frame rates. The shorter display times also reduce the color artifacts described above.

The binary intensity scheme described above provides the shortest frame display time for any given maximum contrast ratio; however, it requires the greatest dynamic range from the light source. To obtain a contrast ratio of 512:1, the light source must have a dynamic range of 256:1. However, non-binary schemes based on the same principle can be constructed that trade frame display time against dynamic range from the light source. For example, consider a light source that has two intensity values, a maximum intensity RI₀ and a minimum intensity I₀. It will be assumed that R is an integer. Consider a display that is to have a contrast ratio of M−1, i.e., each pixel intensity value is a number between 0 and M−1. As noted above, the time to display a component image with this contrast ratio is M−1 time intervals without using the variable light intensity system of the present invention.

In this embodiment of the present invention, the display interval for a component image is divided into two sub-intervals. The first sub-interval is assigned a number of time periods denoted by N₁. The second sub-interval is assigned N₂ time periods. N₁ is the integer part of the quotient (M−1)/R and N₂=R−1. Given a pixel intensity value m for one of the pixels in the component image, the corresponding LCD element will be held open for ml time periods during the first sub-interval and m₂ time periods during the second sub-interval, where m₁ is the integer part of the quotient m/R and m₂=m-m₁R. For example, if R=8 and M=501 (i.e., a contrast ratio of 500) then the first sub-interval would have 62 time periods and the second sub-interval would have 7 time periods. Hence, the component image could be displayed in 69 time periods instead of the 500 time periods required by a light source of constant intensity.

It should be noted that the variable light intensity scheme described above could also be applied to a non-frame sequential display to increase the dynamic range of the display without increasing the frame display times. Consider a display having 3N LCD elements that display the component images shifted in space rather than in time. In this case, all three images are displayed at the same time, and hence, all three light sources are turned on at the same time as described above. Assume that the light source is constructed from LEDs or lasers that can vary the intensity of the light source as described above. In prior art schemes, the maximum contrast ratio that can be generated depends on the amount of time available for displaying the image to prevent motion artifacts when a motion picture is presented on the display and the minimum switching time interval for the LCD elements. If the minimum time period is T, then the maximum contrast ratio is 1/T times the fraction of a second that is available for generating the image. This is typically 1/30^{th} of a second. However, if the display interval is divided into two sub-intervals as described above, the time needed to generate a contrast of M is significantly reduced. For example, in the R=8 example discussed above, a contrast ratio of 500 can be provided in only 69 time periods instead of 500. Conversely if all of the 500 time periods are utilized, a contrast ratio of almost 4000 can be achieved.

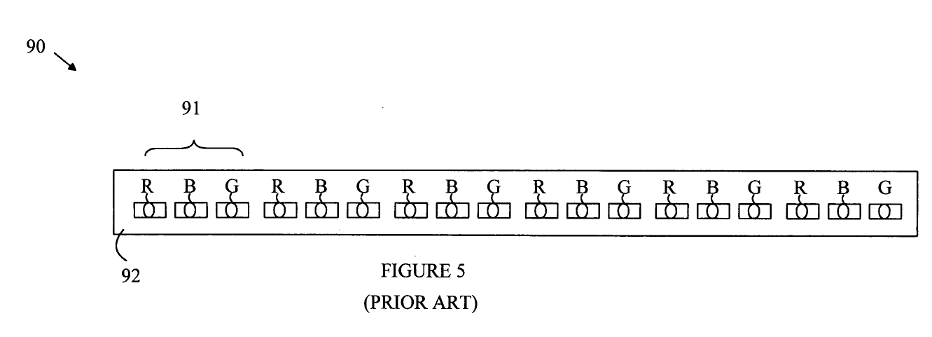

The preferred light source for illuminating the light guide is a linear light source having its axis parallel to one edge of the light source. Prior art LED-based light sources attempt to approximate a linear white light source by providing a linear array of LEDs in which the adjacent LEDs emit different colors. That is, a linear array of red, blue, and green LEDs is constructed by cyclic placing the red, blue, and green LEDs along a line on an appropriate substrate. Such an arrangement is shown in FIG. 5, which illustrates a prior art linear light source. Linear source 90 is constructed by mounting triplets of LEDs on a substrate 92. A typical triplet is shown at 91. This arrangement has a number of drawbacks. First, if prepackaged LEDs are used, the distance between adjacent LEDs can be significant. The light source will only be a good approximation of a linear source at distances that are large compared to the distance between the individual LEDs. Hence, the larger LED separation necessitates a larger mixing zone of the type discussed above. Even if the light source is constructed by mounting unpackaged dies on the substrate, the separation can still be significant. In addition, the fabrication time can be significant, since a large number of individual LEDs must be attached to the substrate one die at a time.

The present invention, in contrast, can be constructed from three separate linear arrays of LEDs. Since the LEDs are identical, a wafer can be cut to provide long linear strips of LEDs that are attached to a substrate. Since the LEDs are spaced at the same spacing as on the wafer, the light source provides a better approximation to a linear light source than the individually mounted LEDs discussed above. In addition, the fabrication time is substantially reduced since only a few such strips are required for a source.

It should also be noted that a large number of small closely packed point light sources is preferable in embodiments in which the intensity of the light source is varied during the frame generation as described above. If the LEDs are sufficiently close together, the source intensity can be varied by turning off selected LEDs. For example, if only every other LED is turned on, the intensity of the source will be reduced by a factor of two. If every fourth LED is turned on, the source intensity will be reduced by a factor 4 and so on.

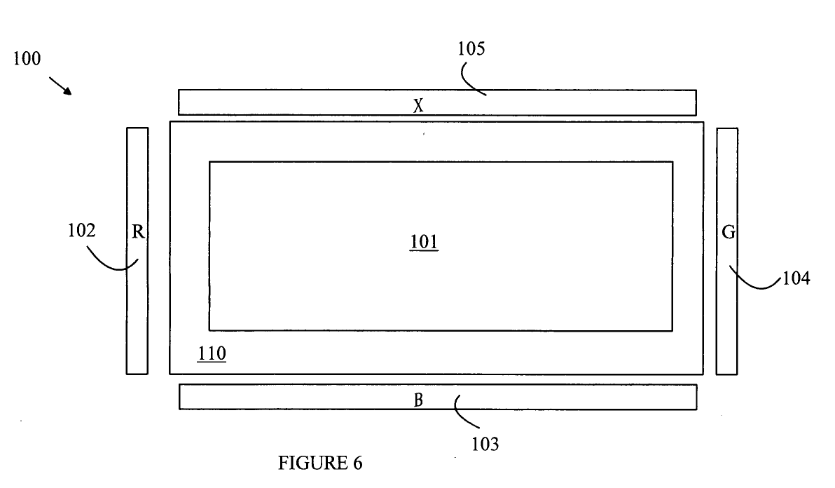

In the embodiment described above with reference to FIG. 4, the individual linear arrays were positioned above one another. However, other placements can be utilized. Refer now to FIG. 6, which is a top view of an LCD display according to another embodiment of the present invention. LCD display 100 utilizes linear light sources that are mounted on different edges of light guide 110. The LCD panel 101 is located in the interior region of the light guide 110 to provide sufficient space between the various LED arrays to average out any intensity fluctuations along the length of the light source. In this example, four different LED sources are used. The sources are shown at 102-105. The fourth source will be discussed in more detail below.

It should be noted that the sources could be of different lengths and intensities without interfering with the operation of the display. If a particular linear source is much brighter than the others, the time periods used in the display of the corresponding component image can be reduced in length. For example, the blue source 103 is significantly longer than the red source, and hence, would produce more light if the sources were equal in luminosity. Similarly, if the source is much weaker than the other sources, longer time periods can be utilized to compensate.

As noted above, the embodiment shown in FIG. 6 utilizes a fourth light source shown at 105. Color reproduction schemes based on four colors are well known in the art, and hence, will not be discussed in detail here. For the purposes of the present discussion, it is sufficient to note that including a fourth color increases the gamut of colors that can be displayed. In addition, certain applications can place particularly high demands on the reproduction of a particular color. For example, flesh tones in TV images are particularly important to human observers, and hence, small deviations from the correct tone are not tolerated. The addition of another color image can provide a means for more accurately reproducing the desired tone.

It should be noted that the present invention is particularly well adapted for constructing custom color displays that utilize different component images or numbers of component images. Since the color is determined by the light sources and not a set of filters that are part of the LCD array, one need only change the light sources and the display algorithm to generate a display based on a new color scheme.

The above-described embodiments divide the display interval for each component image into a plurality of sub-intervals in which the intensity of the light from the light source changes with the sub-interval being processed. In the frame sequential embodiments, all sub-intervals of a given color component image were displayed before going on to the next color component image. However, embodiments in which the display of the sub-images is non-sequential can also be constructed to further reduce the motion artifacts associated with frame sequential displays.

Consider a system in which each color component image is divided into N sub-images, with each sub-image being displayed in a separate time sub-interval. In the above-described embodiments, the red light source is turned on and set at the intensity associated with the first sub-interval and then the first sub-image is displayed by opening the LCD elements for the appropriate time periods. The red light source is then set to the intensity associated with the second sub-interval and the second sub-image is displayed, and so on. After all N red sub-images had been displayed, the blue sub-images were displayed using the blue light source in an analogous manner. Finally, the green sub-images were displayed using the green light source.

It should be noted that the various sub-images are independent of one another, and hence, can be displayed in any order, provided the entire set of sub-images is displayed in a short time interval such that the eye perceives the images to have been generated at the same time. For example, in the above-described sequential embodiment, the first red-sub-image could be displayed followed by the first blue sub-image, followed by the first green sub-image. The second red, blue, and green sub-images would then be displayed and so on. This type of intermixed sub-image display is more resistant to the type of motion artifact discussed above, since the display of the various colors of each sub-image is accomplished in a shorter time. As a result, the motion artifacts are perceived as a change in intensity rather than a change in color. Since the viewer expects a change in intensity when the viewer blinks, these artifacts are less objectionable.

The above-described embodiments of the present invention utilize semiconductor light sources based on LEDs or lasers. Such light sources are preferred because the intensity of light from the light source can be altered in a small fraction of the time allotted to each sub-image. However, any light source that can provide the required intensity levels with sufficiently short switching times can be utilized. For example, a light source that is constructed from a fluorescent light and an electronic shutter could be utilized to provide a fast switching source. The different intensity levels would then be implemented by using a plurality of sources or by using some form of optical attenuator.

The above-identified embodiments of the present invention have been directed to a color display. However, the present invention can be used to construct a monochromatic display having increased dynamic range by substituting the desired light source for the color sources discussed above.

The above-described embodiments of the present invention assume that the spectral output of each light source is the same at each of the intensities used to display the component images. For the purposes of this discussion, the spectral output of a light source is defined to be the relative intensity of the light source as a function of wavelength in the visual portion of the optical spectrum. Two light sources are defined to have the same optical spectrum if the optical spectrum of the first light source can be made identical to that of the second light source by multiplying each point in the first optical spectrum by a constant that is independent of wavelength.

It should be noted that slight shifts in the spectral output of the light source can be tolerated. Such shifts will cause the perceived color of one of the sub-images to shift slightly. However, since the perceived color is a weighted sum of the intensities of the sub-images, the shifts are expected to be small, because the sub-image having the highest intensity will tend to dominate. It should also be noted that in color schemes having more than three colors, the additional colors and the mapping used to generate the assignment of intensities to the various colors could be adjusted to correct for shifts in optical spectrum.

Various modifications to the present invention will become apparent to those skilled in the art from the foregoing description and accompanying drawings. Accordingly, the present invention is to be limited solely by the scope of the following claims.

What is claimed is:

1. A display comprising:
a light source comprising a first light emitter that generates a first light signal having first and second intensities that are greater than zero, said second light intensity being different from said first light intensity;
an LCD panel comprising a plurality of LCD elements, each LCD having a first state in which that LCD element transmits light and a second state in which that LCD element blocks light, said LCD panel being illuminated by said first light signal; and
a controller that controls the state of said LCD elements and said intensity of said first light signal in response to receiving an image to be displayed by said LCD panel, said image comprising a first sub-image and a second sub-image, said controller causing said first sub-image to be displayed when said first light signal has said first intensity and said second sub-image being displayed when said first light signal has said second intensity, said first and second sub-images being displayed in a time period that is less than 0.03 seconds.

2. The display of claim 1 wherein said first light signal comprises light in a first band of wavelengths,
wherein said light source further comprises a second light emitter that generates a second light signal having third and fourth intensities that are greater than zero, said third intensity being different from said fourth intensity, said second light signal comprising light in a second band of wavelengths that is different from said first band of wavelengths, and wherein
said received image further comprises third and fourth sub-images, said controller causing said third sub-image to be displayed when said second light signal has said third intensity and said fourth sub-image to be displayed when said second light signal has said fourth intensity, said first, second, third, and fourth sub-images being displayed in a time period that is less than 0.03 seconds.

3. The display of claim 2 wherein said first sub-image is displayed first and said third sub-image is displayed before said second sub-image.

4. The display of claim 1 wherein said first light emitter comprises an LED.

5. The display of claim 1 wherein said first light emitter comprises a semiconductor laser.

6. The display of claim 1 wherein said first light source comprises a light pipe comprising a layer of transparent material having a top surface, a bottom surface, and a first edge surface, said light pipe being positioned to receive light from said first light emitter through said first edge surface such that said light is totally reflected from said top surface, said light pipe comprising features that redirect some of said light such that some of said redirected light exits through said top surface, said LCD panel overlying said top surface.

7. The display of claim 6 wherein said first light emitter comprises a plurality of semiconductor light emitters arranged in a linear array.

8. The display of claim 6 wherein said layer of transparent material comprises a second edge surface, wherein said light source further comprises a second light emitter that generates a second light signal having third and fourth intensities that are greater than zero, said third intensity being different from said fourth intensity, said second light signal comprising light in a second band of wavelengths that is different from said first band of wavelengths, and wherein said second light emitter is positioned such that light from said second light emitter enters said layer of transparent material through said second edge surface.

9. A method for displaying an image comprising:
generating first and second sub-images from said image;
displaying said first sub-image on an LCD panel using a first light intensity of light from a first light source to illuminate said panel, said LCD panel comprising a plurality of LCD elements, each LCD having a first state in which that LCD element transmits light and a second state in which that LCD element blocks light, said first light source being characterized by a first output spectrum at said first intensity and wherein said first intensity is different from said second intensity and both of said first and second intensities are greater than zero; and
displaying said second sub-image on said LCD panel using a second light intensity from said first light source to illuminate said panel, wherein said first and second sub-images are displayed in a time period that is less than 0.03 seconds.

10. The method of claim 9 further comprising generating third and fourth sub-images from said image; and
displaying said third sub-image on said LCD panel using a third light intensity of light from a second light source to illuminate said panel, said second light source being characterized by a second output spectrum at said third intensity that is different from said first output spectrum, and said third intensity being different from said fourth intensity and both of said third and fourth intensities being greater than zero; and
displaying said fourth sub-image on said LCD panel using a fourth light intensity of light from said second light source to illuminate said panel, wherein said first, second, third, and fourth sub-images are displayed in a time period that is less than 0.03 seconds.

11. The method of claim 9 wherein said first spectral output at said first intensity is the same as said first spectral output at said second intensity.

12. The method of claim 9 wherein said division of said image into said first and second sub-images depends on said first output spectrum at said first intensity and said second intensity.
